(19) United States
(12) Patent Application Publication
(10) Pub. No.: US 2021/0186061 A1
(43) Pub. Date: Jun. 24, 2021

(54) BEVERAGE POWDER COMPRISING POROUS PARTICLES AND PARTIALLY AGGREGATED PROTEIN

(71) Applicant: SOCIETE DES PRODUITS NESTLE S.A., Vevey (CH)

(72) Inventors: Marina Dupas-Langlet, Savigny (CH); Anne-Juliette Dedisse, Bern (CH); Cecile Gehin-Delval, Les Hopitaux Neufs (FR); Markus Kreuss, Freimettigen (CH); Vincent Daniel Maurice Meunier, Epalinges (CH); Celie Puech-Rulliere, Venon (FR); Christophe Joseph Etienne Schmitt, Servion (CH); Madansinh Nathusinh Vaghela, Macedonia, OH (US)

(21) Appl. No.: 16/620,075

(22) PCT Filed: Jun. 6, 2018
(86) PCT No.: PCT/EP2018/064874

§ 371 Date: Dec. 6, 2019

Related U.S. Application Data
(60) Provisional application No. 62/516,199, filed on Jun. 7, 2017.

(30) Foreign Application Priority Data
Jun. 26, 2017 (EP) 17177938.2

(51) Int. Cl. A23L 2/395; A23L 2/66; A23L 2/60; A23L 33/19; A23L 33/185; A23C 9/152; A23C 9/16; A23C 11/06; A23L 2/54; A23J 3/10; A23J 3/14; A23L 3/46; A23P 10/40

(52) U.S. Cl. CPC A23L 2/395; A23C 2240/20; A23L 2/60; A23L 33/19; A23L 33/185; A23C 9/1524; A23C 9/16; A23C 11/06; A23L 2/54; A23J 3/10; A23J 3/14; A23L 3/46; A23P 10/40; A23V 2002/00; A23L 2/66

(57) ABSTRACT

The present invention relates to a beverage powder comprising porous particles and partially aggregated proteins, the porous particles having an amorphous continuous phase comprising a sweetener, a soluble filler and a optionally a surfactant, wherein the porous particles have a closed porosity of between 10 and 80%. A further aspect of the invention is a process for manufacturing a beverage powder.

### FIELD OF THE INVENTION

The present invention relates to a beverage powder comprising porous particles and partially aggregated proteins, the porous particles having an amorphous continuous phase comprising a sweetener, a soluble filler and optionally a surfactant, wherein the porous particles have a closed porosity of between 10 and 80%. A further aspect of the invention is a process for manufacturing a beverage powder.

### BACKGROUND OF THE INVENTION

Soluble coffee beverage powders of the instant “cappuccino” type are commercially available. Usually these products are dry mixes of a soluble coffee powder and a soluble whitener powder. The soluble whitener powder contains pockets of gas, which, upon dissolution of the powder, produce foam. Therefore, upon the addition of water (usually hot), a whitened coffee beverage, which has a foam on its upper surface, is formed; the beverage resembling, to a greater or lesser extent, traditional Italian cappuccino.

The current trend is that consumers are more health conscious and are looking for healthier beverages with less sugar, less fat and fewer calories but without compromising the product taste and texture. In addition, consumers demand a healthier beverage, yet they are not willing to give up the original, indulgent mouthfeel they grew up with and remember, also denoted as richness, texture or creaminess, of the beverages. Thus, many beverages are transitioning from high sugar and/or fat versions to versions with less sugar and/or fat to limit the calories in the beverage. However, sugar and/or fat reduction results in a thin, less pleasing mouthfeel of the beverages. Therefore, there is a need for a solution that improves mouthfeel particularly in reduced sugar/fat beverages to maintain the consumer preference.

### SUMMARY OF THE INVENTION

An object of the present invention is to improve the state of the art and to provide an improved solution to enhance mouthfeel in a beverage, particularly a beverage having reduced sugar and or fat content. The object of the present invention is achieved by the subject matter of the independent claims. The dependent claims further develop the idea of the present invention.

Accordingly, the present invention provides in a first aspect a beverage powder comprising porous particles and partially aggregated proteins, the porous particles having an amorphous continuous phase comprising a sweetener, a soluble filler and optionally a surfactant, wherein the porous particles have a closed porosity of between 10 and 80%. In a second aspect, the invention provides a process for manufacturing a beverage powder comprising the steps;
a) providing an aqueous protein composition;
b) adjusting the pH of the protein composition to 5.5 to 7.1;
c) heating the composition of step b) to a temperature from 65° C. to 100° C. for a period of from 15 seconds (for example 30 seconds) to 90 minutes to form a partially aggregated protein;
d) preparing a mixture comprising sweetener, soluble filler and the partially aggregated protein of step c);
e) subjecting the mixture prepared in step d) to high pressure, for example 50 to 300 bar, for further example 100 to 200 bar;
f) adding gas to the mixture and;
g) drying the mixture to form porous particles having an amorphous continuous phase.

It has been surprisingly found by the inventors that beverage powders comprising porous amorphous particles and partially aggregated proteins show enhanced foamability on reconstitution, producing a stable wet foam. The resulting beverage has an increased viscosity and shows an improvement in the desirable sensory properties of body intensity, milky intensity and mouth-coating. The use of partially agglomerated proteins also increases the porosity of the amorphous particles during manufacture.

Without wishing to be bound by theory, the inventors believe that the amorphous porous particles (for example amorphous porous particles comprising sugar) protect the partially aggregated proteins comprised within them, preventing the partially aggregated proteins from becoming fully denatured and thus preserving their ability to bind water and form networks on re-hydration. A denatured protein would simply form an insoluble particle, liable to precipitate and with none of the desired functionality such as improved foam.

### BRIEF DESCRIPTION OF THE DRAWINGS

FIG. 1 shows scanning electron microscopy (SEM) micrographs of powders A (partially aggregated milk proteins), B (amorphous porous sugar/partially aggregated milk proteins) and C (amorphous porous sugar/milk powder).

FIG. 2 is a schematic representation of the apparatus to measure tastant gradient on dissolution. Four refractive index probes numbered P1 (bottom) to P4 (top) fixed in a beaker.

FIG. 3 shows a plot of sugar concentration at four heights in a beaker during dissolution of powder B.

### DETAILED DESCRIPTION OF THE INVENTION

Consequently the present invention relates in part to a beverage powder comprising porous particles and partially aggregated proteins, the porous particles having an amorphous continuous phase comprising a sweetener, a soluble filler and optionally a surfactant, wherein the porous particles have a closed porosity of between 10 and 80% (for example between 20 and 60%). An embodiment of the invention is a beverage powder comprising porous particles, the porous particles having an amorphous continuous phase comprising a sweetener, a soluble filler and optionally a surfactant, wherein partially aggregated proteins are dispersed in the amorphous continuous phase and the porous particles have a closed porosity of between 10 and 80% (for example between 20 and 60%). In the context of the present invention the term beverage powder refers to a powder which is dissolved and/or dispersed in water to form a beverage.

An aspect of the invention relates to a beverage powder comprising partially aggregated proteins.

According to the present invention the term ‘amorphous’ as used herein is defined as being a glassy solid, essentially free of crystalline material and should be interpreted in line with conventional understanding of the term.

According to the present invention the term glass transition temperature (Tg) as used herein is to be interpreted as is commonly understood, as the temperature at which an amorphous solid becomes soft upon heating or brittle upon cooling. The glass transition temperature is always lower than the melting temperature (Tm) of the crystalline state of the material. An amorphous material can therefore be conventionally characterised by a glass transition temperature, denoted Tg. A material is in the form of an amorphous solid below its glass transition temperature.

Several techniques can be used to measure the glass transition temperature and any available or appropriate technique can be used, including differential scanning calorimetry (DSC) and dynamic mechanical thermal analysis (DMTA)

In an embodiment of the present invention the amorphous continuous phase of the porous particles according to the invention is characterised as having a glass transition temperature of 40° C. or higher, for example at least 50° C., for further example at least 60° C.

Advantageously in contrast to prior art solutions, the amorphous continuous phase of the porous particles according to the present invention is less hygroscopic making such material easier to handle and store.

According to the present invention the term porous as used herein is defined as having multiple small pores, voids or interstices, for example of such a size to allow air or liquid to pass through. In the context of the present invention porous is also used to describe the aerated nature of the particles according to the present invention.

In the present invention the term porosity as used herein is defined as a measure of the empty spaces (or voids or pores) in a material and is a ratio of the volume of voids to total volume of the mass of the material between 0 and 1, or as a percentage between 0 and 100%

Porosity can be measured by means known in the art. For instance, the particle porosity can be measured by the following equation:

Porosity=Vp−Vcm/Vp×100 wherein Vp is the Volume of the particle and Vcm is the volume of the matrix or bulk material.

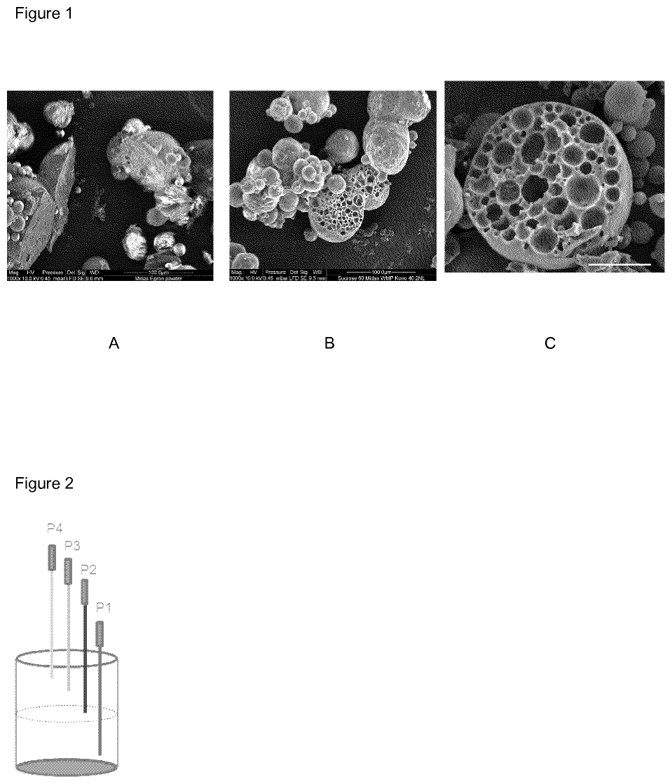

According to the present invention the term closed or internal porosity as used herein refers in general terms to the total amount of void or space that is trapped within the solid. As can be seen in FIG. 1, porous particles according to the present invention show an internal microstructure wherein the voids or pores are not connected to the outside surface of the said particles. In the present invention the term closed porosity is further defined as the ratio of the volume of closed voids or pores to the particle volume.

A potential problem when producing a reduced sugar version of an existing beverage powder is that the reduction in sugar leads to a reduction in serving volume, for example when a high intensity sweetener is introduced as full or partial replacement of sucrose. Consumers may be confused by the change in the volume of powder that is needed to make a good tasting beverage, indeed they may continue to use the same volume, for example the same measuring spoon, resulting in using too much powder. Having porous particles in the powder, the volume of powder required to make a good tasting beverage can be maintained for the sugar-reduced product.

Increasing the porosity of the amorphous particles increases their dissolution speed in water. However, increasing the porosity of the particles also increases their fragility. It is advantageous that the porous amorphous particles of the present invention exhibit closed porosity. Particles with closed porosity, especially those with many small spherical pores, are more robust than particles with open pores, as the spherical shapes with complete walls distribute any applied load evenly.

The porous particles comprised within the beverage powder of the invention may have a closed porosity of between 10 to 80%, for example between 15 and 70%, for further example between 20 and 60%.

The porous particles comprised within the beverage powder of the invention may have a normalized specific surface of between 0.10 and 0.18 m⁻¹, for example between 0.12 and 0.17 m⁻¹. The porous particles comprised within the beverage powder of the invention may have a normalized specific surface of between 0.10 and 0.18 m⁻¹ (for example between 0.12 and 0.17 m⁻¹) and a particle size distribution D90 of between 30 and 140 microns (for example between 40 and 90 microns).

Normalized specific surface=interstitial surface area of pores+external surface area of material/solid volume of material

According to the present invention the term density is the mass per unit volume of a material. For porous powder, three terms are commonly used; apparent density, tap density and absolute density. Apparent density (or envelope density) is the mass per unit volume wherein pore spaces within particles are included in the volume. Tap density is the density obtained from filling a container with the sample material and vibrating it to obtain near optimum packing. Tap density includes inter-particle voids in the volume whereas apparent density does not. In absolute density (or matrix density), the volume used in the density calculation excludes both pores and void spaces between particles.

In an embodiment of the present invention the porous particles comprised within the beverage powder of the invention have an apparent density of between 0.3 to 1.5 g/cm³, for example 0.5 to 1.0 g/cm³, for further example 0.6 to 0.9 g/cm³.

D90 values and D_{4,3} values are common methods of describing a particle size distribution. The D90 is the diameter where 90% of the mass of the particles in the sample have a diameter below that value. In the context of the present invention the D90 by mass is equivalent to the D90 by volume. The term “D_{4,3} particle size” is used conventionally in the present invention and is sometimes called the volume mean diameter. The D90 value and D_{4,3} values may be measured for example by a laser light scattering particle size analyser. Other measurement techniques for particle size distribution may be used depending on the nature of the sample. For example, the D90 value of powders may conveniently be measured by digital image analysis (such as using a Camsizer XT).

The porous particles comprised within the beverage powder of the invention may have a particle size distribution D90 below 450 microns, for example below 140 microns, for further example between 30 and 140 microns. The porous particles comprised within the beverage powder of the invention may have a particle size distribution D90 of less than 90 microns, for example less than 80 microns, for further example less than 70 microns. The porous particles comprised within the beverage powder of the invention may have a particle size distribution D90 of between 40 and 90 microns, for example between 50 and 80 microns.

The porous particles comprised within the beverage powder of the invention may be approximately spherical, for example they may have a sphericity of between 0.8 and 1. Alternatively, the particles may be non-spherical, for example they may have been refined, for example by milling.

The porous particles comprised within the beverage powder of the invention may be obtained by foam drying, freeze drying, tray drying, fluid bed drying and the like. Preferably the porous particles comprised within the beverage powder of the invention are obtained by spray drying with pressurized gas injection.

The spray in a spray drier produces droplets that are approximately spherical and can be dried to form approximately spherical particles. However, spray driers are typically set to produce agglomerated particles, as agglomerated powders provide advantages as ingredients in terms of flowability and lower dustiness, for example an open top spray drier with secondary air recirculation will trigger particle agglomeration. The agglomerated particles may have a particle size distribution D90 of between 120 and 450 μm. The size of spray-dried particles with or without agglomeration may be increased by increasing the aperture size of the spray-drying nozzle (assuming the spray-drier is of sufficient size to remove the moisture from the larger particles). The porous particles comprised within the beverage powder of the invention may comprise un-agglomerated particles, for example at least 80 wt. % of the amorphous porous particles comprised within the composition of the invention may be un-agglomerated particles. The porous particles comprised within the beverage powder of the invention may be agglomerated particles which have been refined.

When formed into agglomerates, the agglomerated particles generally retain convex rounded surfaces composed of the surfaces of individual spherical particles. Refining spherical or agglomerated spherical particles causes fractures in the particles which leads to the formation of non-rounded surfaces. The refined particles according to the invention may have less than 70% of their surface being convex, for example less than 50%, for further example less than 25%.

The porous particles comprised within the beverage powder of the invention may comprise a sweetener, a soluble filler and a surfactant, all distributed throughout the continuous solid phase of the particles. Higher concentrations of surfactant may be present at the gas interfaces than in the rest of the continuous phase, but the surfactant is in the continuous phase inside the particles, not just coated onto the exterior. For example, the surfactant may be present in the interior of the particles according to the beverage powder of the invention.

According to the present invention the term sweetener as used herein refers to substance which provides a sweet taste. The sweetener may be a sugar, for example a mono, di or oligo-saccharide. The sweetener may be selected from the group consisting of sucrose, fructose, glucose, dextrose, galactose, allulose, maltose, high dextrose equivalent hydrolysed starch syrup, xylose, and combinations thereof. Accordingly, the sweetener comprised within the amorphous continuous phase of the particles according to the invention may be selected from the group consisting of sucrose, fructose, glucose, dextrose, galactose, allulose, maltose, high dextrose equivalent hydrolysed starch syrup xylose, and any combinations thereof. The sweetener may be sucrose.

In a preferred embodiment the amorphous continuous phase of the particles according to the invention comprises sweetener (for example sucrose) in the amount of 5 to 70%, preferably 10 to 50%, even more preferably 20 to 40%.

Without being bound by theory it is believed that particles comprising sweetener (for example sugar) in the amorphous state provide a material which dissolves more rapidly than crystalline sugar particles of a similar size.

The soluble filler increases the particle volume and hence the amount of gas which may be contained within the porous particles. The soluble filler also aids the formation and stability of an amorphous phase. The soluble filler according to the beverage powder of the invention may be a biopolymer, for example a sugar alcohol, saccharide oligomer or polysaccharide. The soluble filler may be a polysaccharide. In an embodiment, the soluble filler may be a sugar alcohol, saccharide oligomer or polysaccharide which less sweet than crystalline sucrose on a weight basis. In an embodiment, the porous particles according to the beverage powder of the present invention comprise a soluble filler in the amount of 5 to 70%, for example 10 to 40%, for further example 10 to 30%, for still further example 40 to 70%. According to the beverage powder of the present invention the soluble filler may be selected from the group consisting of sugar alcohols (for example isomalt, sorbitol, maltitol, mannitol, xylitol, erythritol and hydrogenated starch hydrolysates), lactose, maltose, fructo-oligosaccharides, alpha glucans, beta glucans, starch (including modified starch), natural gums, dietary fibres (including both insoluble and soluble fibres), polydextrose, methylcellulose, maltodextrins, inulin, dextrins such as soluble wheat or corn dextrin (for example Nutriose®), soluble fibre such as Promitor® and any combination thereof.

In an embodiment of the present invention the soluble filler may be selected from the group consisting of lactose, maltose, maltodextrins, soluble wheat or corn dextrin (for example Nutriose®), polydextrose, soluble fibre such as Promitor® and any combinations thereof.

The porous particles comprised within the beverage powder of the present invention may have a moisture content between 0.5 and 6 wt. %, for example between 1 and 5 wt. %, for further example between 1.5 and 3 wt. %.

In an embodiment, the amorphous continuous phase of the particles according to the invention comprise a colloid stabilizer, for example a foam stabilizer. The colloid stabilizer may be a finely divided solid stabilizing a foam by the Pickering effect. The colloid stabilizer may be particles of protein. The colloid stabilizer may be partially aggregated proteins. The colloid stabilizer may be a surfactant. To form the amorphous continuous phase of the particles an aqueous solution may be dried or cooled to form a glass. A colloid stabilizer aids the formation of porosity.

In an embodiment, the amorphous continuous phase of the particles of the present invention comprises a surfactant in the amount of 0.5 to 15 wt. %, for example 1 to 10 wt. %, for further example 1 to 5 wt. %, for further example 1 to 3 wt. %. The surfactant may be selected from the group consisting of lecithin, whey proteins, milk proteins, non-dairy proteins, sodium caseinate, lysolecithin, fatty acid salts, lysozyme, sodium stearoyl lactylate, calcium stearoyl lactylate, lauroyl arginate, sucrose monooleate, sucrose monostearate, sucrose monopalmitate, sucrose monolaurate, sucrose distearate, sorbitan monooleate, sorbitan monostearate, sorbitan monopalmitate, sorbitan monolaurate, sorbitan tristearate, PGPR, PGE and any combinations thereof. For example, the surfactant may be sodium caseinate or lecithin.

It should be noted that soluble fillers derived from milk powder such as skimmed milk powder inherently comprise the surfactant sodium caseinate. Whey powder (for example sweet whey) inherently comprises whey protein.

The surfactant comprised within the amorphous continuous phase of the particles according to the present invention may be a non-dairy protein. In the context of the present invention the term “non-dairy proteins” refers to proteins that are not found in bovine milk. The primary proteins in bovine milk are caseins and whey proteins. Some consumers desire to avoid milk proteins in their diets, for example they may suffer from milk protein intolerance or milk allergy and so it is advantageous to be able to offer food products free from dairy proteins. The surfactant comprised within the amorphous continuous phase of the particles of the present invention may be selected from the group consisting of pea proteins, potato proteins, wheat gluten, egg albumin proteins (for example ovalbumin, ovotransferrin, ovomucoid, ovoglobulin, ovomucin and/or lysozyme), clupeine, soy proteins, tomato proteins, Brassicaceae seed protein and combinations of these. For example the non-dairy protein comprised within the particles of the invention may be selected from the group consisting of pea proteins, potato proteins, wheat gluten, soy proteins, and combinations of these.

In an embodiment, the amorphous continuous phase of the particles according to the present invention may comprise a non-dairy protein in the amount of 0.5 to 15%, preferably 1 to 10%, more preferably 1 to 5%, even more preferentially 1 to 3%.

Some consumers wish to avoid dairy products in their diet. In an embodiment, the amorphous continuous phase of the particles according to the present invention may be free from milk ingredients. For example, the amorphous continuous phase of the particles according to the present invention may comprise sucrose; a soluble filler selected from the group consisting of maltose, maltodextrins, soluble wheat or corn dextrin, polydextrose, soluble fibre and combinations of these; and a surfactant selected from the group consisting of pea proteins, potato proteins, wheat gluten, egg albumin proteins, clupeine, soy proteins, oat protein, tomato proteins, Brassicaceae seed protein and combinations of these.

In an embodiment, the beverage powder of the invention may comprise partially aggregated proteins, for example the porous particles according to the beverage powder of the invention may comprise partially aggregated proteins. The partially aggregated proteins may comprise proteins selected from the group consisting of soy proteins (for example soy glycinin, for further example conglycinin), egg proteins (for example ovalbumin, for further example ovaglobulins), rice proteins, almond proteins, oat proteins, pea proteins, potato proteins, wheat proteins (for example gluten), milk proteins (for example whey protein, for further example casein) and combinations of these. The partially aggregated proteins may comprise milk proteins and plant proteins. The partially aggregated proteins may comprise (for example consist of) at least two proteins selected from the group consisting of soy proteins, egg proteins, rice proteins, almond proteins, oat proteins, pea proteins, potato proteins, wheat proteins, casein, whey proteins and combinations of these. The partially aggregated proteins may comprise (for example consist of) milk proteins and soy proteins. The partially aggregated proteins may comprise (for example consist of) milk proteins and pea proteins. The partially aggregated proteins may comprise (for example consist of) milk proteins and potato proteins. The partially aggregated proteins may comprise (for example consist of) pea proteins and soy proteins. The partially aggregated proteins may comprise (for example consist of) pea proteins and potato proteins. The proteins may have been partially aggregated by the application of shear, for example processing a protein solution or suspension in a high shear mixer for at least 15 minutes. The proteins may have been partially aggregated by a heat treatment at a temperature between 65° C. and 100° C. for a period of between 50 seconds and 90 minutes at a pH of between 5.5 and 7.1. The higher the temperature applied the shorter the time required to reach partial aggregation. Heating for too long should be avoided as this fully denatures the proteins leading to them precipitating out as insoluble particles. In an embodiment, the proteins have been partially aggregated by a heat treatment at a temperature between 90° C. and 100° C. for a period of between 15 seconds and 4 minutes (for example between 30 seconds and 3 minutes, for further example between 50 seconds and 2 minutes) at a pH of between 5.5 and 7.1. In an embodiment, the proteins have been partially aggregated by a heat treatment at a temperature between 65° C. and 75° C. for a period of between 10 minutes and 30 minutes at a pH of between 5.5 and 7.1. It is beneficial to apply mixing during heating so as to avoid localized and uneven heating. Once partially aggregated proteins are formed, homogenization processes should generally be avoided as they break the aggregates. The process conditions described provide clumps of partially agglomerated proteins with a size small enough to pass through a spray nozzle (for example during spray-drying), but still provide a positive impact on the mouthfeel of the beverage according to the invention. The partially aggregated proteins may be in the form of protein aggregates dispersed within the amorphous porous particles. The beverage powder of the invention may comprise between 1 and 30 wt. % partially aggregated proteins. The partially aggregated proteins may have a D_{4,3} particle size of between 1 and 30 μm. The partially aggregated proteins create or enhance the desirable sensory properties of body intensity, milky intensity and mouth-coating. The partially aggregated proteins also increase the porosity of the porous particles, for example during spray drying with application of gas pressure.

In the context of the present invention the term partially aggregated proteins means that a proportion of the proteins have been aggregated. The content of soluble protein after the aggregation process is preferably below or equal to 30%, preferably below or equal to 20% in relation to the total protein content; the majority of the proteins being embedded in aggregated structures. Partially aggregated particles may form networks. Partially aggregated proteins can bind or entrap water and fat particles to increase viscosity and mouthfeel. Partially aggregated particles may not form insoluble particles for example as protein precipitates.

In an embodiment, the beverage powder of the invention comprises partially aggregated milk proteins, for example the porous particles according to the beverage powder of the invention may comprise partially aggregated milk proteins. The partially aggregated milk proteins may be whey-protein and casein; the weight ratio of whey-protein:casein may be from 0.3-0.5. In the context of the current invention the term “milk” (unless stated otherwise) refers to mammalian milk, for example milk from cows, sheep or goats. The milk according to embodiments of the present invention may be cows' milk.

“Whey protein” is a mixture of globular proteins isolated from whey. It is a typical by-product of the cheese making process. “Casein” pertains to a family of related phospho-proteins commonly found in mammalian milk, i.e. αs1-, αs2-, β- and κ-caseins. They make up about 80% of the proteins in cows' milk and are typically the major protein component of cheese. The “ratio” or “weight ratio” of whey-protein versus casein protein (i.e. whey-protein:casein) is defined in the present invention as the ratio of the weights (i.e. dry weights) of those respective proteins to each other.

In an embodiment of the invention wherein the beverage powder of the invention comprises partially aggregated milk proteins, the partially aggregated milk proteins may be prepared from an aqueous composition comprising whole milk or skimmed milk, for example by adjusting the pH of the aqueous composition to a value between 5.8 and 6.3 (for example between 6.0 and 6.1) and heating to a temperature of between 85 and 100° C. (for example between 90 and 100° C.) for between 50 seconds and 10 minutes (for example between 3 and 7 minutes). In an embodiment of the invention wherein the beverage powder of the invention comprises partially aggregated milk proteins, the partially aggregated milk proteins may be prepared from an aqueous composition comprising whole milk or skimmed milk, for example by adjusting the pH of the aqueous composition to a value between 5.8 and 6.3 (for example between 6.0 and 6.1) and heating to a temperature between 90° C. and 100° C. for a period of between 15 seconds and 4 minutes (for example between 30 seconds and 3 minutes, for further example between 50 seconds and 2 minutes). In an embodiment of the invention wherein the beverage powder of the invention comprises partially aggregated milk proteins, the partially aggregated milk proteins may be prepared from an aqueous composition comprising whole milk or skimmed milk, for example by adjusting the pH of the aqueous composition to a value between 5.8 and 6.3 (for example between 6.0 and 6.1) and heating to a temperature between 65° C. and 75° C. for a period of between 10 minutes and 30 minutes.

In an embodiment of the invention wherein the beverage powder of the invention comprises partially aggregated milk proteins, the partially aggregated milk proteins may be whey-protein and casein (for example micellar casein). The casein to whey protein ratio may be from 90/10 to 60/40. Divalent cations such as calcium or magnesium cations may be used in the formation of the partially aggregated protein.

In an embodiment, the beverage powder of the invention comprises partially aggregated non-dairy proteins, for example the porous particles according to the beverage powder of the invention may comprise partially aggregated non-dairy proteins. The non-dairy proteins may be selected from the group consisting of soy proteins, egg proteins, rice proteins, almond proteins, oat proteins, pea proteins, potato proteins, wheat proteins and combinations of these. For example, the non-dairy proteins may be selected from the group consisting of soy, egg, rice, almond and wheat protein. The non-dairy proteins may be at least two proteins selected from the group consisting of soy proteins, egg proteins, rice proteins, almond proteins, oat proteins, pea proteins, potato proteins, wheat proteins and combinations of these, for example the non-dairy proteins may be at least two proteins selected from the group consisting of soy, egg, rice, almond and wheat protein. The partially aggregated non-dairy proteins may be prepared from an aqueous composition comprising non-dairy proteins by adjusting the pH of the aqueous composition to a pH value between 5.8 and 6.3 and heating to a temperature of between 65 and 95° C. (for example between 68° C. and 93° C.) for between 3 and 90 minutes. For example the partially aggregated non-dairy proteins may be prepared from an aqueous composition comprising non-dairy proteins by adjusting the pH of the aqueous composition to a pH value between 5.8 and 6.3 and heating to a temperature of between 90° C. and 100° C. for a period of between 15 seconds and 4 minutes (for example between 30 seconds and 3 minutes for further example between 50 seconds and 2 minutes). For example the partially aggregated non-dairy proteins may be prepared from an aqueous composition comprising non-dairy proteins by adjusting the pH of the aqueous composition to a pH value between 5.8 and 6.3 and heating to a temperature between 65° C. and 75° C. for a period of between 10 minutes and 30 minutes.

The amorphous continuous phase of the particles according to the present invention may comprise (for example consist on a dry basis of) sucrose and skimmed milk. The sucrose may be present at a level of at least 30 wt. % in the particles. The ratio of sucrose to skimmed milk may be between 0.5 to 1 and 2.5 to 1 on a dry weight basis, for example between 0.6 to 1 and 1.5 to 1 on a dry weight basis. The skimmed milk may have a fat content below 1.5 wt. % on a dry weight basis, for example below 1.2 wt. %. The components of skimmed milk may be provided individually and combined with sucrose, for example the amorphous continuous phase of the particles according to the present invention may comprise sucrose, lactose, casein and whey protein. Sucrose and skimmed milk provide an amorphous porous particle which has good stability against recrystallization without necessarily requiring the addition of reducing sugars or polymers. For example the amorphous continuous phase of the particles according to the present invention may be free from reducing sugars (for example fructose, glucose or other saccharides with a dextrose equivalent value. The dextrose equivalent value may for example be measured by the Lane-Eynon method). For further example the amorphous continuous phase of the particles according to the present invention may be free from oligo- or polysaccharides having a three or more saccharide units, for example maltodextrin or starch.

The amorphous continuous phase of the particles according to the present invention may comprise sucrose, lactose, partially aggregated milk protein and optionally milk fat. The sucrose may be present at a level of at least 30 wt. % in the particles.

The amorphous continuous phase of the particles according to the present invention may comprise sucrose, maltodextrin (for example a maltodextrin with a DE between 12 and 20), and a partially aggregated protein, the protein being obtained from a source selected from the group consisting of egg, rice, almond, wheat and combinations of these. The sucrose may be present at a level of at least 30 wt. % in the particles.

The beverage powder of the present invention may be free from ingredients not commonly used by consumers when preparing food in their own kitchen, in other words, the beverage powder of the present invention may consist of so-called “kitchen cupboard” ingredients.

The beverage powder of the present invention may be a powder to reconstitute with milk or water. The beverage powder of the present invention may be a coffee, cocoa or malt beverage. The beverage powder of the present invention may be a flavoured milk powder or a powdered soup. The beverage powder may be a coffee mix, comprising soluble coffee together with a coffee creamer and a sweetener. For example the porous particles according to the invention may provide sweetening in the coffee mix. The beverage powder may be for use in beverage preparation machines, for example beverage vending machines.

An aspect of the invention relates to a process for manufacturing a beverage powder wherein heat, acidic conditions and time are applied to the beverage powder components in a way to provide a partially denatured protein system within the beverage powder. The invention provides a process for manufacturing a beverage powder comprising the steps; a) providing an aqueous protein composition; b) adjusting the pH of the protein composition to 5.5 to 7.1; c) heating the composition of step b) to a temperature from 65° C. to 100° C. for a period of from 15 seconds (for example 30 seconds) to 90 minutes to form a partially aggregated protein; d) preparing a mixture (for example an aqueous mixture) comprising sweetener, soluble filler and the partially aggregated protein of step c); e) subjecting the mixture prepared in step d) to high pressure, for example 50 to 300 bar, for further example 100 to 200 bar; f) adding gas to the mixture and; g) drying (for example spraying and drying) the mixture to form porous particles having an amorphous continuous phase. The heating step c may be performed with the application of mixing, for example high shear mixing. This is not essential, but it is beneficial to apply mixing during heating so as to avoid localized and uneven heating. The heating step c may be performed by the direct steam injection. Once partially aggregated proteins are formed, homogenization processes should generally be avoided as they break the aggregates.

In an embodiment, the heating step c is performed by heating to a temperature from 90° C. and 100° C. for a period of between 15 seconds and 4 minutes (for example between 30 seconds and 3 minutes, for further example between 50 seconds and 2 minutes) to form a partially aggregated proteins. In a further embodiment, the heating step c is performed by heating to a temperature from 65° C. and 75° C. for a period of between 10 minutes and 30 minutes.

The aqueous protein composition provided in step (a) may comprise at least two proteins. The aqueous protein composition provided in step (a) may comprise at least two proteins selected from the group consisting of soy proteins, egg proteins, rice proteins, almond proteins, oat proteins, pea proteins, potato proteins, wheat proteins, casein, whey proteins and combinations of these. It will be understood that the ingredients required to be added in step d) to prepare a mixture comprising sweetener, soluble filler and the partially aggregated protein will depend on the ingredients already present in the aqueous protein composition of step a). For example, in an embodiment where the aqueous protein composition is liquid milk, the aqueous protein composition already contains soluble filler (i.e. lactose) and so the addition of further soluble filler is optional. If fat is present in the aqueous protein composition then the composition may be homogenized before the heating of step c).

Any suitable acid or base may be used to adjust the pH of the protein composition, for example an organic acid such as citric acid or phosphoric acid. For manufacturing convenience, the formation of the partially aggregated protein may be performed at a different location from the formation of the porous particles. For example, the aggregated protein composition of step c) may be dried to a powder for transportation and/or storage. The aggregated protein composition can then be reconstituted in water during the preparation of the mixture comprising sweetener, soluble filler and the partially aggregated protein.

In an embodiment, the mixture prepared in step d) may comprise 30% water, for example 40% water and for further example 50% water. Preferably the sweetener and soluble filler are fully dissolved and the partially aggregated protein is either dissolved or well dispersed. The mixture prepared in step d) is subjected to high-pressure, for example a pressure greater than 2 bar, typically 50 to 300 bar, for example 100 to 200 bar, for further example 100 to 150 bar.

The gas is preferably dissolved in the mixture before drying (for example before spraying and drying), the mixture comprising dissolved gas being held under high pressure up to the point of drying (for example spraying and drying). Typically the gas is selected from the group consisting of nitrogen, carbon dioxide, argon, air and nitrous oxide. The gas may be air. For example the gas may be nitrogen and it is added for as long as it takes to achieve full dissolution of gas in the said mixture. For example the time to reach full dissolution may be at least 2 minutes, for example at least 4 minutes, for further example at least 10 minutes, for further example at least 20 minutes, for further example at least 30 minutes.

The drying of step g) according to the process of the invention may be spray-drying. The spraying nozzle (for example the spray-drying nozzle) should be selected such that it minimizes the damage to the partially aggregated proteins, for example the damage caused by shear as the partially aggregated proteins pass through the nozzle. The spray drying nozzle may for example have a diameter greater than or equal to 0.2 mm.

The mixture according to an embodiment of the process of the invention may be dried by foam drying, freeze drying, tray drying, fluid bed drying and the like. The drying may occur during the process of spray-drying. The pressurised mixture being sprayed to form droplets which are then dried in a column of air, for example warm air, the droplets forming a powder.

In an embodiment of the process of the invention, the gas of step f) may be selected from the group consisting of nitrogen, carbon dioxide, argon, air and nitrous oxide and the drying of step g) may be spray drying. The gas may be nitrogen.

In a further embodiment of the process of the invention, the aqueous protein composition of step a) may comprise whey protein and casein; the pH may be adjusted to between 5.8 and 6.2 in step b); and the composition may be heated in step c) to a temperature from 85° C. to 100° C. for a period of from 1 minute to 10 minutes.

In a further embodiment of the process of the invention, the aqueous protein composition of step a) may comprise skimmed milk or whole milk; the pH may be adjusted to between 6.0 and 6.2 in step b); the composition may be heated in step c) to a temperature from 90° C. to 100° C. for a period of from 3 minute to 8 minutes; and the mixture of step d) may be prepared by adding sucrose as the sweetener.

Partially aggregated proteins may be formed in the presence of cations. In a further embodiment of the process of the invention, the aqueous protein composition of step a) may have a concentration of 1 to 15 wt. % protein, comprising micellar casein and whey proteins with a casein to whey protein ratio of 90/10 to 60/40; the pH may be adjusted to between 6.1 and 7.1 in step b) and divalent cations may be added to provide a concentration of 3 to 8 mM free divalent cations; and the composition may be heated in step c) to a temperature from 85° C. to 100° C. for a period of from 30 seconds to 3 minutes. The divalent cations may for example be selected from the group consisting of Ca cations, Mg cations and a combination thereof.

Non-dairy proteins may be used in the process of the invention. In a further embodiment of the process of the invention, the aqueous protein composition of step a) may comprise a non-dairy protein selected from the group consisting of soy (for example soy glycinin or conglycinin), egg (for example ovalbumin or ovaglobulins), rice, almond, wheat (for example gluten) and combinations of these; the pH is adjusted to between 5.8 and 6.1 in step b); and the composition is heated in step c) to a temperature from 65° C. to 95° C. (for example 68° C. to 93° C.) for a period of from 15 seconds (for example 30 seconds, for further example 3 minutes) to 90 minutes.

In a further embodiment of the process of the invention, the pH of the mixture maybe adjusted to between 6.5 and 7.0 before the drying of step g).

Those skilled in the art will understand that they can freely combine all features of the present invention disclosed herein. In particular, features described for the product of the present invention may be combined with the process of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

SEM Images

Powders were examined by Scanning Electron Microscopy (SEM). Each powder was glued onto a metallic specimen stub equipped with a double-sided conductive tape. The stub was shaken to allow a good spreading of the powder. To see the inner structure of the powder, particles were cut with a razor blade on a part of the stub.

The samples were coated with a 10 nm gold layer using a Leica SCD500 sputter coater and were subsequently imaged in a low vacuum mode at 10 kV using a Quanta F200 Scanning Electron Microscope or a Phenom Pro tabletop Electron Microscope.

Confocal Images

After adding staining agents, samples were deposed inside a 1 mm deep plastic chamber closed by a glass slide coverslip to prevent compression and drying artefacts. Imaging was done with a LSM 710 confocal microscope upgraded with an Airyscan detector (Zeiss, Oberkochen, Germany). Acquisition and image treatments were done using the Zen 2.1 software.

Materials: Fast Green FCF (Sigma-Aldrich, Saint Louis, Mo., United states): 1% in water solution. The solution is diluted 100 times for use. Nile red (Sigma, Saint Louis, Mo., United states): 0.25 mg/100 mL EtOH. The solution is diluted 100 times for use.

Acquisitions parameters: Excitation wavelength: 633 nm; Emission: LP=645 nm. Excitation wavelength: 561 nm, Emission: BP=570-620 nm.

Particle Size

The particles size distribution of aggregates was measured by Malvern Mastersizer 2000. Sample is introduced in the Hydro 200G unit. Measurement is performed two times using the Fraunhofer method and an average taken. The powders comprising the aggregates are reconstituted before the measurement. Water is first heated at 40° C. In a 250 mL-beaker, 1.00 g hot water is added to 1.5 g powder. In order to ensure that the powder is completely reconstituted, the mix is stirred during 2 h at ambient temperature before measurement.

Particle size distribution of powders was measured by Camsizer XT (Retsch Technology GmbH, Germany). The technique of digital image analysis is based on the computer processing of a large number of sample's pictures taken at a frame rate of 277 images/seconds by two different cameras, simultaneously. Characteristic particle size d₁₀, d₅₀ and d₉₀ are calculated from normalized curves, corresponding to the particle size of 3.0%, 50% and 90% of the particles number respectively. The values reported in the study are d₉₀. The uncertainty is of 3.0 μm for the d₉₀ in the range of particle size of our powders.

Density

The matrix density was determined by DMA 4500 M (Anton Paar, Switzerland AG). The sample is introduced into a U-shaped borosilicate glass tube that is excited to vibrate at its characteristic frequency, which depends on the density of the sample. The accuracy of the instrument is 0.00005 g/cm³ for density and 0.03° C. for temperature.

The apparent density of powders was measured by Accupyc 1330 Pycnometer (Micrometrics Instrument Corporation, US). The instrument determines density and volume by measuring the pressure change of helium in a calibrated volume with an accuracy to within 0.03% of reading plus 0.03% of nominal full-scale cell chamber volume.

Porosity

Closed porosity was calculated from the matrix density and the apparent density, according to the following equation:

$$Closed porosity = 100 \cdot ( 1 - \frac{{ρ}_{apparent}}{{ρ}_{matrix}} )$$

Viscosity

Shear viscosity values were obtained with a rheometer (MCR 500 or 501 Anton Paar Physica, Germany). Samples were previously dissolved in water 3.0 wt %. Experiments were performed with a concentric cylinders (Couette) geometry with a serrated surface (CC27/P6, SN:21236) at 25° C. in duplicate.

Foamability and Foam Stability Analysis

Powders are reconstituted at 13% wt total solid at 40° C. The foaming properties are determined by the method developed by Guillerme and co-workers [J. Text. Stud., 24, 287-302.2 (1993)], using Foamscan (Teclis, Longessaigne, France). The principle is to foam a defined quantity of sample dispersion by gas sparging through a porous sintered glass disk (porosity and gas flow are controlled). The foam generated rises along a cylindrical glass column where its volume is followed by image analysis using a CCD camera. The amount of liquid incorporated in the foam and the foam homogeneity are followed by measuring the conductance in the cuvette containing the liquid and at different heights in the column by means of electrodes [Kato et al., J. Food Sci., 48, 62-65 (1983)].

The foaming properties of the samples are measured by pouring 60 mL of the dispersions into cuvette and sparging N₂ at 80 mL.min⁻¹. This flow rate is found to allow an efficient foam formation before strong gravitational drainage occurs. The porosity of the sintered glass disk used for testing these foaming properties allows formation of air bubbles having diameters between 10 to 16 microns. Bubbling is stopped after a volume of 200 cm³ of foam was reached. At the end of the bubbling, foam capacity (FC=volume of foam/volume of gas injected) is calculated [Carrera Sanchez et al., Food Hydrocolloids, 19, 407-416 (2005)]. In addition, total foam volume and foam liquid stability (time for the foam to drain 50% of its initial liquid content) were followed with time at 25±2° C. All experiments were duplicated.

### Example 1 Porous Powder Production

Formation of Partially Aggregated Proteins

Liquid whole milk (total solids=12.5%) was heated and evaporated at 65° C.-70° C. until reaching 45% total solids. The pH was adjusted to 6.1 with 5% citric acid solution and then a heat treatment at 95° C. was applied during 2 minutes in a high shear mixer. The concentrate was cooled at 65° C.-70° C. and then spray-dried with a low-pressure two-phase nozzle to form a dry powder (A) comprising partially aggregated proteins. The particle size of the aggregates in the powder was measured as D[4,3]=8.31 microns.

Formation of Porous Particles Having an Amorphous Continuous Phase

Sucrose and the dry powder comprising partially aggregated proteins were reconstituted in water at 50% total solids. The ratio of sucrose to the dry powder was 60/40 by weight. The reconstituted liquid was pasteurized at 75° C. for 5 min. The liquid was cooled to 60° C. and then spray dried with gas injection using a NIRO SD6.3-N spray-dryer (GEA, Denmark). The liquid is pressurized and then combined with nitrogen injected after the high pressure pump. The spraying pressure was around 120-130 bars, with the injection pressure about 10 bars above the spraying pressure. Typical flowrate was approximately 10 L/h and the nozzle diameter was 0.2 mm. Porous particles were produced (B) having an amorphous continuous phase and comprising partially aggregated proteins. The particle size of the protein aggregates in the porous particles was measured as D[4,3]=4.14 microns. The presence of protein aggregates was also confirmed by confocal microscopy. The protein aggregates survived being incorporated into the porous particles, but with some reduction in size.

For manufacturing porous particles without partially aggregated proteins (C), the same process was applied except that the dry powder comprising partially aggregated proteins was replaced by full fat milk powder at the same ratio, 60/40 sucrose/milk powder.

Moisture and Particle Characterisation

Physical and chemical characterization was performed. Results of moisture properties are presented in the Table below. It can be observed that both porous powders exhibit a glass transition temperature.

| | Description | Moisture [%] | T_{g} [° C.] | a_{w} [—] |
|---|---|---|---|---|
| B | Porous sugar/partially | 1.99 | 46.44 | 0.165 |
| | aggregated milk | | | |
| | proteins | | | |
| C | Porous sugar/milk | 1.93 | 50.0 | 0.106 |
| | powder | | | |

Physical properties are shown in the table below:

| | | Apparent | Closed | |
|---|---|---|---|---|
| | | density [—] | Porosity [%] | d₉₀ [μm] |
| B | Porous sugar/partially | 0.471 | 68.0 | 92.4 |
| | aggregated milk | | | |
| | proteins | | | |
| C | Porous sugar/milk | 0.543 | 63.1 | 61.4 |
| | powder | | | |

The addition of partially aggregated proteins increased the closed porosity of the sugar/milk particles.

Scanning Electron Microscopy (SEM) micrographs of powders A, B and C are shown in FIG. 1. The powder (A) of partially aggregated milk proteins has very little internal porosity. The porous powders; sugar/partially aggregated milk powder (B) and sugar/milk powder (C) show high porosity with very little open porosity (which would be visible as air channels at the surface of the particles).

Viscosity

Viscosity of the three powders reconstituted in water are shown below:

| | A | B | C |
|---|---|---|---|
| Average Viscosity at 13.9 s⁻¹ | 1.440 | 1.346 | 1.192 |
| [mPa · s] | | | |
| Std Dev | 0.006 | 0.006 | 0.004 |

The powder of partially aggregated milk (A) produced the most viscous liquid when reconstituted. The porous sugar/milk powder (C) had the lowest viscosity. The viscosity of the porous sugar/partially aggregated milk powder (B) lay in-between A and C.

Foamability and Foam Stability Analysis

The foamability of the three powders was examined. The porous sugar/milk powder (C) did not foam. Similarly, a dry mix of sucrose and whole milk powder in the same proportions as used for the porous powders (60/40) did not foam. The table below shows the foam capacity and the foam liquid stability for a dry mix of sucrose and powder A (60/40 ratio) compared with the porous sugar/partially aggregated milk powder B.

| | Foam | Foam liquid |
|---|---|---|
| | capacity [—] | stability [s] |
| Dry mix of sucrose and partially | 1.00 | 59 |
| aggregated proteins (A) | | |
| Porous sugar/partially | 1.20 | 211 |
| aggregated milk proteins (B) | | |

Both powders showed a good foam capacity (1 or greater) but the porous sugar/milk powder with partially aggregated milk proteins has the best foam capacity. The foam liquid stability of the porous sugar/milk powder with partially aggregated milk proteins B was higher than the dry mix of sucrose and powder A. It is surprising that the combination of partially agglomerated proteins within amorphous porous particles would foam better than partially agglomerated proteins alone, considering that the comparative amorphous porous particles not made with partially agglomerated proteins do not foam at all. The powder comprising porous particles and partially aggregated proteins (B) was observed to produce a wetter foam with rounder bubbles. This is associated with a more creamy mouthfeel. A foam with more liquid surrounding the bubbles will deliver more liquid to the consumer as they sip the foam. Where the foam comprises sucrose, this results in a sweeter tasting foam. Initial taste delivery is the main driver for overall taste perception, so by delivering a sweet foam as the initial taste the consumer will perceive the overall beverage to be sweeter. This may allow the overall amount of sucrose in the beverage to be reduced without spoiling enjoyment.

Formation of Tastant Gradient on Beverage Powder Reconstitution

The porous sugar/partially aggregated milk protein powder (B) was added to a beaker of water and the concentrations obtained at different heights of the beaker measured by refractive index. Four refractive index probes were fixed in a beaker at different heights, so that different layer concentrations could be measured (FIG. 2). The probes are numbered P1 (bottom) to P4 (top). The refractive index probes were connected to a FTI-10 universal fiber optic conditioner (FISO Technologies) and 3.0 refractive indexes were recorded FISO Commander 2 software. Calibration of each sensor was preliminary performed by drawing a calibration curve at different sugar concentrations between 1% and 10% at room temperature (23-25° C.). For each test, the beaker was filled with 300 grams of Millipore filtered water before the sweet powder was added with careful stirring.

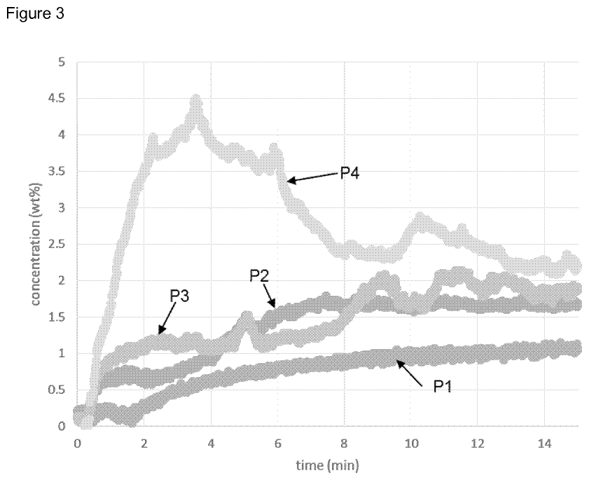

FIG. 3 shows the dissolution of 5 g of powder B; amorphous porous particles with partially aggregated proteins. FIG. 3 shows that the refractive index recorded by the upper probe (P4) was markedly higher than at the other probe positions. This is believed to be due to the dissolved sucrose remaining “trapped” in the foam.

Tasting

A panel of 11 tasters compared beverages made from powders A, B and C with a reference using multiple comparison profiling. The beverages were made up with 4.84 g of soluble coffee and 24.58 g of powder (A, B or C) dissolved in 460 g water. The reference was a reconstituted cappuccino powder (3% sugar; 4% whole milk powder). The beverages made with powders A and B (comprising partially agglomerated proteins) were found to have significantly more body intensity, milky intensity and mouth-coating than both the reference and powder C.

1. Beverage powder comprising porous particles and partially aggregated proteins, the porous particles having an amorphous continuous phase comprising a sweetener, and a soluble filler, wherein the porous particles have a closed porosity of between 10 and 80%.

2. A beverage powder according to claim 1 wherein the partially aggregated proteins are dispersed in the amorphous continuous phase of the porous particles.

3. A beverage powder according to claim 1 wherein the partially aggregated proteins are selected from the group consisting of soy proteins, egg proteins, rice proteins, almond proteins, oat proteins, pea proteins, potato proteins, wheat proteins, milk proteins and combinations of these.

4. A beverage powder according to claim 1 wherein the partially aggregated proteins have a D_{4,3} particle size of between 1 and 30 μm.

5. A beverage powder according to claim 1 wherein the sweetener is sucrose.

6. A beverage powder according to claim 1 wherein the amorphous continuous phase of the porous particles comprises sucrose and skimmed milk.

7. A beverage powder according to claim 1 wherein the amorphous continuous phase of the porous particles comprises sucrose, lactose, and partially aggregated milk protein.

8. A beverage powder according to claim 1 wherein the amorphous continuous phase of the porous particles comprises sucrose, maltodextrin and a partially aggregated protein, the protein being obtained from a source selected from the group consisting of egg, rice, almond, wheat and combinations of these.

9. Process for manufacturing a beverage powder comprising the steps;
a) providing an aqueous protein composition;
b) adjusting the pH of the protein composition to 5.5 to 7.1;
c) heating the composition of step b) to a temperature from 65° C. to 100° C. for a period of from 15 seconds to 90 minutes to form a partially aggregated protein;
d) preparing a mixture comprising sweetener, soluble filler and the partially aggregated protein of step c);
e) subjecting the mixture prepared in step d) to high pressure, for example 50 to 300 bar;
f) adding gas to the mixture; and
g) drying the mixture to form porous particles having an amorphous continuous phase.

10. A process according to claim 9 wherein the aqueous protein composition of step a) comprises whey protein and casein; the pH is adjusted to between 5.8 and 6.2 in step b); and the composition is heated in step c) to a temperature from 85° C. to 100° C. for a period of from 1 minute to 10 minutes.

11. A process according to claim 9 wherein the aqueous protein composition of step a) comprises skimmed milk or whole milk; the pH is adjusted to between 6.0 and 6.2 in step b); the composition is heated in step c) to a temperature from 90° C. to 100° C. for a period of from 3 minute to 8 minutes; and the mixture of step d) is prepared by adding sucrose as the sweetener.

12. A process according to claim 9 wherein the aqueous protein composition of step a) has a concentration of 1 to 15 wt. % protein, comprises micellar casein and whey proteins with a casein to whey protein ratio of 90/10 to 60/40; the pH is adjusted to between 6.1 and 7.1 in step b) and divalent cations are added to provide a concentration of 3 to 8 mM free divalent cations, and the composition is heated in step c) to a temperature from 85° C. to 100° C. for a period of from 30 seconds to 3 minutes.

13. A process according to claim 9 wherein the aqueous protein composition of step a) comprises a non-dairy protein selected from the group consisting of soy, egg, rice, almond, wheat and combinations of these; the pH is adjusted to between 5.8 and 6.1 in step b), and the composition is heated in step c) to a temperature from 65° C. to 95° C. for a period of from 15 seconds to 90 minutes.

14. A process according to claim 9 wherein the pH of the mixture is adjusted to between 6.5 and 7.0 before the spraying and drying of step g).

15. A process according to claim 9 wherein the gas of step f) is selected from the group consisting of nitrogen, carbon dioxide, argon, air and nitrous oxide and the spraying and drying of step g) is spray drying.
